(19) United States
(12) Patent Application Publication
(10) Pub. No.: US 2026/0205576 A1
(43) Pub. Date: Jul. 16, 2026

(54) METHODS OF APPARATUS OF INTRA MODE CODING

(71) Applicant: MEDIATEK INC., Hsinchu City (TW)

(72) Inventors: Yi-Wen CHEN, San Jose, CA (US); Olena CHUBACH, San Jose, CA (US); Ching-Yeh CHEN, Hsinchu City (TW); Chih-Wei HSU, Hsinchu City (TW); Tzu-Der CHUANG, Hsinchu City (TW)

(21) Appl. No.: 19/136,447

(22) PCT Filed: Nov. 3, 2023
(86) PCT No.: PCT/CN2023/129555

§ 371 Date: Jun. 6, 2025

Related U.S. Application Data
(60) Provisional application No. 63/386,923, filed on Dec. 12, 2022.

(51) Int. Cl. H04N 19/11; H04N 19/176; H04N 19/593; H04N 19/70

(52) U.S. Cl. CPC H04N 19/11; H04N 19/176; H04N 19/593; H04N 19/70

(57) ABSTRACT

Aspects of the disclosure provide a method, an apparatus, and a non-transitory computer-readable medium for video coding. The method can include determining an intra mode look-up table (IMLUT) for intra predicting a current block of video data, wherein the IMLUT includes a subset of all available intra prediction modes that are available for intra predicting the current block. The method can include constructing an intra prediction mode list an intra prediction mode list based on the IMLUT, and encoding or decoding the current block of the video data based on the intra prediction mode list.

### INCORPORATION BY REFERENCE

This present application claims the benefit of U.S. Provisional Application No. 63/386,923, “Methods of Apparatus of Intra Mode Coding” filed on Dec. 12, 2022, which is incorporated herein by reference in its entirety.

### TECHNICAL FIELD

The present disclosure relates to intra prediction mode coding in video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Video coding standards, such as high efficiency video coding (HEVC) standard, and the like, use video compression technologies to improve coding efficiency and improve video quality. Intra mode coding is one of the video compression technologies that performs the compression within a single frame/picture.

### SUMMARY

Aspects of the disclosure provide a method of video coding. The method can include determining an intra mode look-up table (IMLUT) for intra predicting a current block of video data, wherein the IMLUT includes a subset of all available intra prediction modes that are available for intra predicting the current block. The method can include constructing an intra prediction mode list based on the IMLUT, and encoding or decoding the current block of the video data based on the intra prediction mode list.

In an embodiment, the determining the IMLUT can further include signaling or receiving syntax elements associated with the IMLUT into or from a bitstream of the video data at one of a sequence level, a picture level, a slice level, a coding tree unit (CTU) level, a coding unit (CU) level, or a block level.

In an embodiment, the determining the IMLUT can further include determining the IMLUT based on at least one of a block size or a block shape of the current block of the video data.

In an embodiment, the determining the IMLUT can further include determining the IMLUT based on one of intra prediction modes of all coded CUs of a previously coded slice or a previously coded picture, intra prediction modes of all coded CUs of a current slice or a current picture including the current block, intra prediction modes of all coded CUs of a reference picture of the current block, or intra prediction modes of all coded CUs of a collocated reference picture of the current block. In an example, a temporal layer of the current picture which includes the current block is the same or higher than a temporal layer of the previously coded picture corresponding to the IMLUT of the current slice or current picture.

In an embodiment, the constructing the intra prediction mode list can further include constructing the intra prediction mode list using only intra prediction modes in the IMLUT.

In an embodiment, the constructing the intra prediction mode list can further include inserting intra prediction modes in the IMLUT into the intra prediction mode list before an intra prediction mode not in the IMLUT.

In an embodiment, the constructing the intra prediction mode list can further include inserting intra prediction modes in the IMLUT into the intra prediction mode list according to a predefined order. In an example, the predefined order is an ascending order of mode indexes of the intra prediction modes in the IMLUT.

In an embodiment, the method can further include, in response to one of a predefined number of CTU rows, a tile, a slice, or a picture having been processed, clearing all intra prediction modes in the IMLUT.

In an embodiment, the method can further include adding an intra prediction mode of the current block into the IMLUT based on a first-in-first-out (FIFO) rule. In an example, the method can further include performing a redundancy check on the intra prediction mode added into the IMLUT.

In an embodiment, the method can further include inserting an intra prediction mode in a most probable mode (MPM) list after the intra prediction modes in the IMLUT and before an intra prediction mode not in the MPM list, the MPM list being generated based on neighboring blocks of the current block.

In an embodiment, the intra prediction mode list includes an MPM list and a non-MPM list, and the constructing can further include constructing the MPM list based on the IMLUT. In an example, a number of intra prediction modes in the MPM list is M, a number of intra prediction modes in the IMLUT is N, and the constructing the MPM list can further include, in response to M>N, inserting the intra prediction modes in the IMLUT into the MPM list before an intra prediction mode not in the IMLUT, and in response to M≤N, inserting a subset of the intra prediction modes in the IMLUT into the MPM list. In an example, the method can further include, in response to M≤N, inserting at least one remaining intra prediction mode in the IMLUT into the non-MPM list.

In an embodiment, the intra prediction mode list includes an MPM list generated based on neighboring blocks of the current block and a non-MPM list generated based on the IMLUT. In an example, the intra prediction modes in the IMLUT is on top of the non-MPM list.

Aspects of the disclosure provide an apparatus of video coding comprising processing circuitry. The processing circuitry can determine an IMLUT for intra predicting a current block of video data, wherein the IMLUT includes a subset of all available intra prediction modes that are available for intra predicting the current block. The processing circuitry can construct an intra prediction mode list based on the IMLUT, and encode or decode the current block of the video data based on the intra prediction mode list.

Aspects of the disclosure provide a non-transitory computer-readable medium storing instructions that, when executed by a processor, cause the processor to perform the method of video coding.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows four splitting types 101-104 in the multi-type tree structure.

FIG. 2 shows a signaling mechanism 200 of the partition splitting information in a quadtree with a nested multi-type tree coding tree structure.

FIG. 3 shows a CTU 300 divided into multiple CUs with a quadtree with a nested multi-type tree coding block structure.

FIG. 4A illustrates intra prediction modes 400 used in HEVC.

FIG. 4B illustrates intra prediction modes 410 used in VVC.

FIG. 4C illustrates intra prediction modes 420 including wide-angle intra prediction (WAIP) modes used in VVC.

FIGS. 5A-5B show examples of a reference configuration for a non-square block 500.

FIG. 6A shows neighboring blocks for constructing an MPM list for a current block 600.

FIG. 6B shows a process for constructing the MPM list used in HEVC.

FIGS. 7A-7E show examples of constructing an intra prediction mode list of a current block based on an IMLUT of the current block in HEVC according to embodiments of the disclosure.

FIGS. 8A-8E show examples of constructing an intra prediction mode list of a current block based on an IMLUT of the current block in VVC according to embodiments of the disclosure.

FIG. 9 shows a process 900 of video coding according to an embodiment of the present disclosure.

FIG. 10 shows a computer system 1000 suitable for implementing certain embodiments of the disclosed subject matter.

### DETAILED DESCRIPTION OF EMBODIMENTS

### I. Partitioning of the CTUs Using a Tree Structure

In high efficiency video coding (HEVC), a coding tree unit (CTU) can be split into coding units (CUs) by using a quaternary-tree structure denoted as coding tree to adapt to various local characteristics. A decision of whether to code a picture area using inter-picture (temporal) or intra-picture (spatial) prediction can be made at a leaf CU level. Each leaf CU can be further split into one, two, or four prediction units (PUs) according to a PU splitting type. Inside one PU, the same prediction process can be applied, and relevant information can be transmitted to a decoder on a PU basis. After obtaining a residual block by applying the prediction process based on the PU splitting type, a leaf CU can be partitioned into transform units (TUs) according to another quaternary-tree structure similar to the coding tree for the CU. One key feature of the HEVC structure is that it has multiple partition conceptions including CU, PU, and TU.

In versatile video coding (VVC), a quadtree with a nested multi-type tree using binary and ternary splits segmentation structure replaces the concepts of multiple partition unit types, by removing the separation of the CU, PU, and TU concepts except as needed for CUs that have a size too large for a maximum transform length, and thus can support more flexibility for CU partition shapes. In the coding tree structure, a CU can have either a square or rectangular shape. A CTU can be first partitioned by a quaternary tree (i.e., quadtree) structure. Then, the quaternary tree leaf nodes can be further partitioned by a multi-type tree structure.

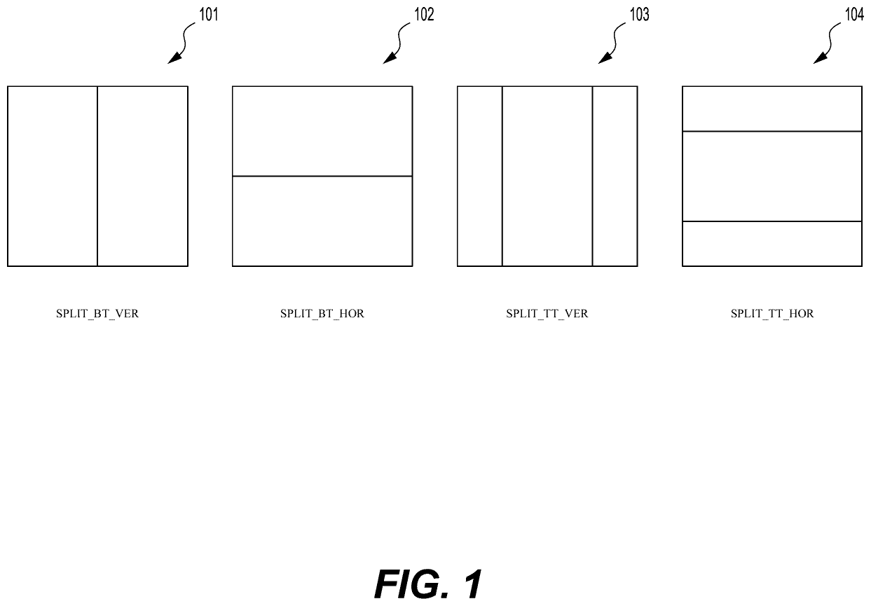

FIG. 1 shows four splitting types 101-104 in the multi-type tree structure. The four splitting types are vertical binary splitting 101 (SPLIT_BT_VER), horizontal binary splitting 102 (SPLIT_BT_HOR), vertical ternary splitting 103 (SPLIT_TT_VER), and horizontal ternary splitting 104 (SPLIT_TT_HOR). The multi-type tree leaf nodes can be referred to as coding units (CUs), and unless a CU is too large for the maximum transform length, this segmentation is used for prediction and transform processing without any further partitioning. This means that, in most cases, the CU, PU, and TU have the same block size in the quadtree with a nested multi-type tree coding block structure. The exception occurs when the maximum supported transform length is smaller than a width or height of a color component of the CU.

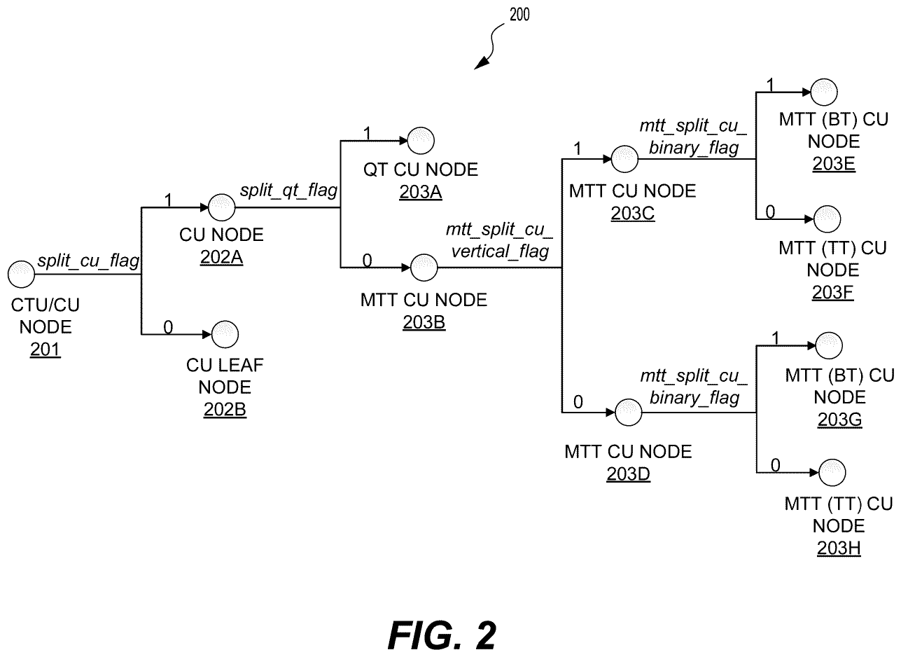

FIG. 2 shows a signaling mechanism 200 of the partition splitting information in a quadtree with a nested multi-type tree coding tree structure. A CTU 201 is treated as a root of a quaternary tree and is first partitioned by a quaternary tree structure. Each quaternary tree leaf node 202A-202B (when sufficiently large to allow it) is then further partitioned by a multi-type tree structure. In the quadtree with the nested multi-type tree coding tree structure, for each CU node 203A-203H, a first flag (split_cu_flag) is signaled to indicate whether the node is further partitioned. If the current CU node is a quadtree CU node (e.g., CU node 202A), a second flag (split_qt_flag) is signaled to indicate whether the current node is a quadtree (QT) partitioning (e.g., CU node 203A) or a multi-type tree (MTT) partitioning mode (e.g., CU node 203B). When a node is partitioned with an MTT partitioning mode, a third flag (mtt_split_cu_vertical_flag) is signaled to indicate a splitting direction, and then a fourth flag (mtt_split_cu_binary_flag) is signaled to indicate whether the split is a binary split (e.g., CU node 203E and CU node 203G) or a ternary split (e.g., CU node 203F and CU node 203H). Based on the values of mtt_split_cu_vertical_flag and mtt_split_cu_binary_flag, the multi-type tree splitting mode (MttSplitMode) of a CU can be derived as shown in the table below.

TABLE 1

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

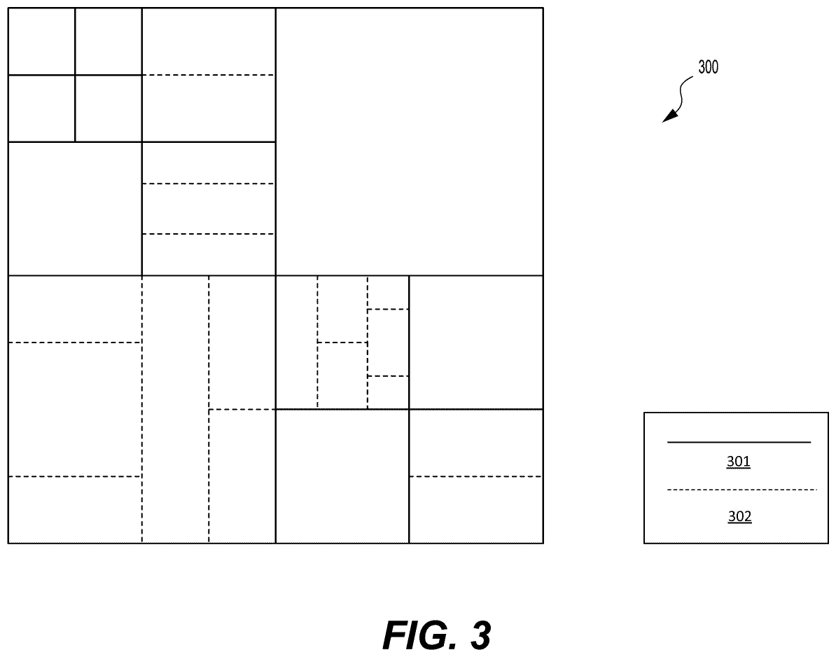

FIG. 3 shows a CTU 300 divided into multiple CUs with a quadtree with a nested multi-type tree coding block structure. The bold block edges 301 represent quadtree partitioning and the dotted block edges 302 represent multi-type tree partitioning. The quadtree with the nested multi-type tree partition can provide a content-adaptive coding tree structure comprised of CUs. A size of the CU may be as large as the CTU 300 or as small as 4×4 in units of luma samples. For the case of the 4:2:0 chroma format, a maximum chroma coding block (CB) size is 64×64 and a minimum size chroma CB consists of 16 chroma samples.

In VVC, a maximum supported luma transform size is 64×64 and a maximum supported chroma transform size is 32×32. When a width (or height) of a CB is longer than the maximum transform width (or height), the CB can be automatically split along the horizontal and/or vertical direction to meet the transform size restriction in the corresponding direction. Parameters defined for the quadtree with the nested multi-type tree coding tree scheme are listed in the table below. These parameters are specified by sequence parameter set (SPS) syntax elements and can be further refined by picture header syntax elements.

TABLE 2

| | |
|---|---|
| CTU size | the root node size of a quaternary tree |
| MinQTSize | the minimum allowed quaternary tree leaf node size |
| MaxBtSize | the maximum allowed binary tree root node size |
| MaxTtSize | the maximum allowed ternary tree root node size |
| MaxMttDepth | the maximum allowed hierarchy depth of multi-type tree |
| | splitting from a quadtree leaf |
| MinCbSize | the minimum allowed coding block node size |

In one example of the quadtree with the nested multi-type tree coding tree structure, a CTU size of a CTU is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is first applied to the CTU to generate quaternary tree leaf nodes. Size of the quaternary tree leaf nodes may be from 16×16 (i.e., the MinQTSize) to 128×128 (i.e., the CTU size). If a size of a leaf QT node is 128×128, the leaf node will not be further split by the binary tree since the size exceeds the MaxBtSize and MaxTtSize (i.e., 64×64). Otherwise, the leaf quadtree node can be further partitioned by the multi-type tree. Therefore, the quaternary tree leaf node is also the root node for the multi-type tree and has a multi-type tree depth (mttDepth) of 0. When the multi-type tree depth reaches MaxMttDepth (i.e., 4), no further splitting is considered. When the multi-type tree node has a width equal to MinCbsize, no further horizontal splitting is considered. Similarly, when the multi-type tree node has a height equal to MinCbsize, no further vertical splitting is considered.

In VVC, the coding tree scheme supports the ability for the luma and chroma to have a separate block tree structure. For P and B slices, luma and chroma CTBs in one CTU can share the same coding tree structure (single tree splitting). However, for I slices, the luma and chroma can have separate block tree structures. When separate block tree mode (dual-tree splitting) is applied, a luma CTB can be partitioned into CUs by one coding tree structure, and corresponding chroma CTBs can be partitioned into chroma CUs by another coding tree structure. This means that a CU in an I slice may consist of a coding block of the luma component or coding blocks of two chroma components, and a CU in a P or B slice always consists of coding blocks of all three color components unless the video is monochrome.

### II. Intra Chroma Partitioning and Prediction Restriction

In hardware video encoders and decoders, processing throughput may drop when a picture has small intra blocks because of sample processing data dependency between neighboring intra blocks. A predictor generation of an intra block requires top and left boundary reconstructed samples from neighboring blocks. Therefore, intra prediction has to be sequentially processed block by block.

In HEVC, a smallest intra CU includes 8×8 luma samples. The luma component of the smallest intra CU can be further split into four 4×4 luma intra PUs, but the chroma components of the smallest intra CU cannot be further split. Therefore, the worst case of a hardware processing throughput occurs when 4×4 chroma intra blocks or 4×4 luma intra blocks are processed. In VVC, in order to improve the worst-case throughput, chroma intra CBs smaller than 16 chroma samples (size 2×2, 4×2, and 2×4) and chroma intra CBs with a width smaller than 4 chroma samples (size 2×N) are disallowed by constraining the partitioning of chroma intra CBs.

In a single coding tree, a smallest chroma intra prediction unit (SCIPU) is defined as a coding tree node whose chroma block size is larger than or equal to 16 chroma samples and has at least one child luma block smaller than 64 luma samples, or a coding tree node whose chroma block size is not 2×N and has at least one child luma block 4×N luma samples. It is required that in each SCIPU, all CBs are inter, or all CBs are non-inter, i.e., either intra or intra block copy (IBC). In the case of a non-inter SCIPU, it is further required that chroma of the non-inter SCIPU shall not be further split and luma of the SCIPU is allowed to be further split. In this way, the small chroma intra CBs with a size less than 16 chroma samples or with a size of 2×N are removed. In addition, chroma scaling is not applied in the case of a non-inter SCIPU. Therefore, no additional syntax is signaled, and whether a SCIPU is non-inter can be derived by the prediction mode of the first luma CB in the SCIPU. A type of a SCIPU can be inferred to be non-inter if the current slice is an I-slice or the current SCIPU has a 4×4 luma partition thereof after further split one time (because no inter 4×4 is allowed in VVC); otherwise, the type of the SCIPU (inter or non-inter) can be indicated by one flag before parsing the CUs in the SCIPU.

For the dual tree in an intra picture, the 2×N intra chroma blocks are removed by disabling vertical binary and vertical ternary splits for 4×N and 8×N chroma partitions, respectively. The small chroma blocks with sizes of 2×2, 4×2, and 2×4 are also removed by partitioning restrictions. In addition, a restriction on a picture size can be considered to avoid 2× 2/2×4/4×2/2×N intra chroma blocks at a corner of the picture by considering a picture width and height to be a multiple of max (8, MinCbSizeY).

### III. Intra Prediction Modes

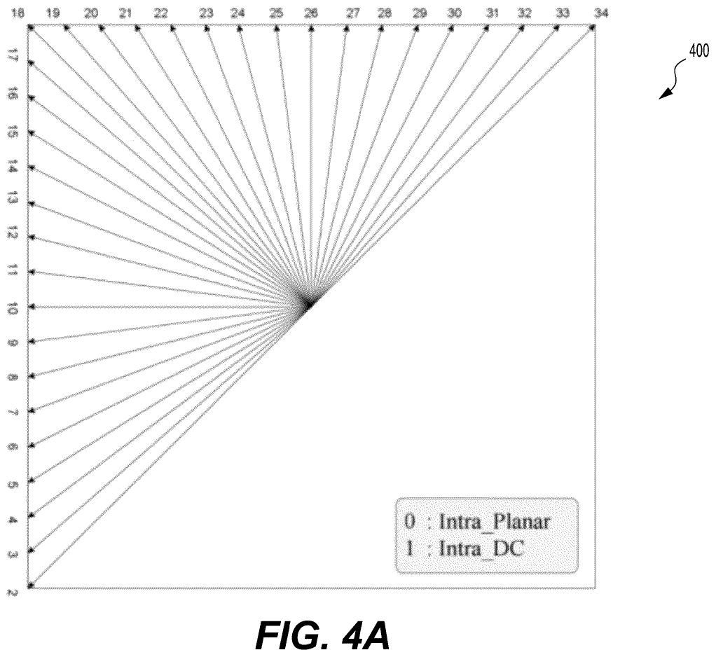

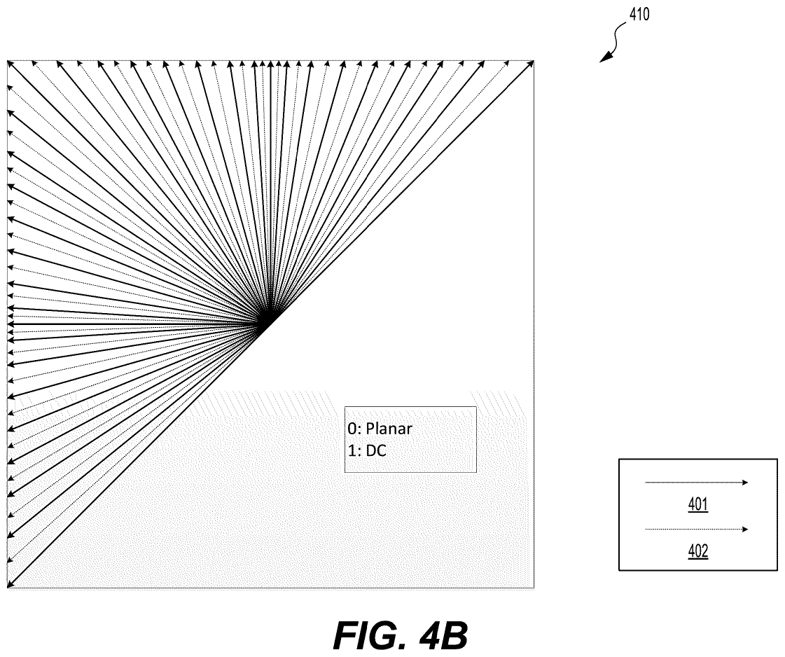

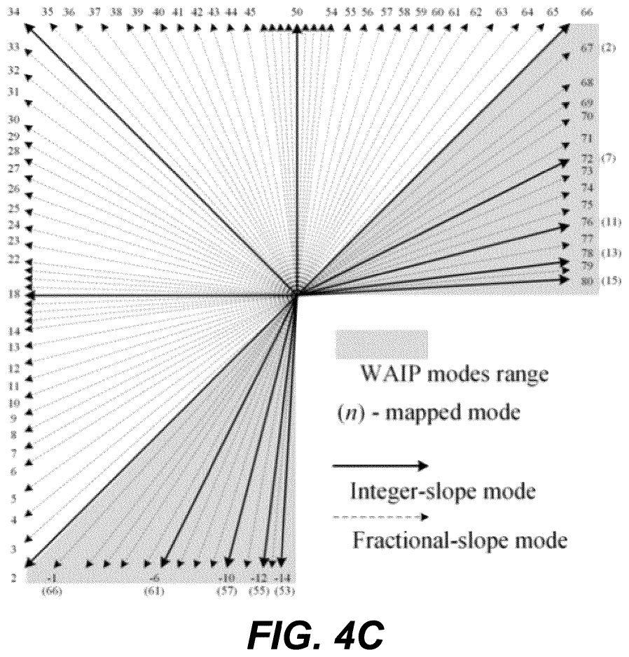

FIG. 4A illustrates intra prediction modes 400 used in HEVC. The intra prediction modes 400 include 35 intra predictions modes which are planar (mode 0), DC (mode 1), and 33 directional modes (mode 2 to mode 34).

FIG. 4B illustrates intra prediction modes 410 used in VVC. To capture the arbitrary edge directions presented in a natural video, a number of directional intra modes in VVC is extended from 33, as used in HEVC, to 65. The new directional modes 402 not in HEVC and the original directional modes 401 in HEVC are shown in FIG. 4B, the planar and DC modes remain the same. These denser directional intra prediction modes apply for all block sizes and for both luma and chroma intra predictions.

FIG. 4C illustrates intra prediction modes 420 including wide-angle intra prediction (WAIP) modes used in VVC. The WAIP modes can be represented by mode-14 to mode-1 and mode 66 to mode 80. The WAIP modes can be used for non-square blocks. In order to keep a total number of the intra prediction modes unchanged (i.e., 67), the WAIP modes can adaptively replace some non-wide-angle intra prediction modes for the non-square blocks.

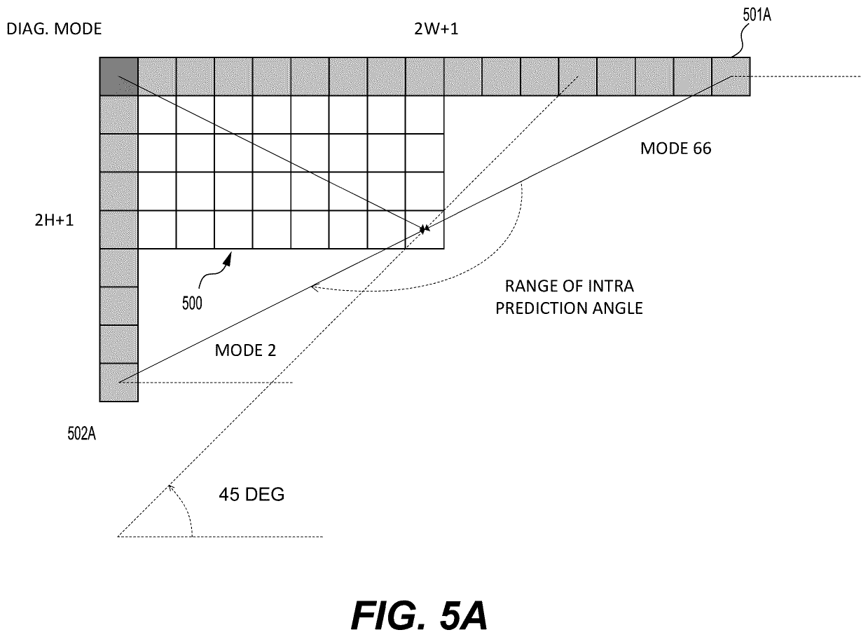

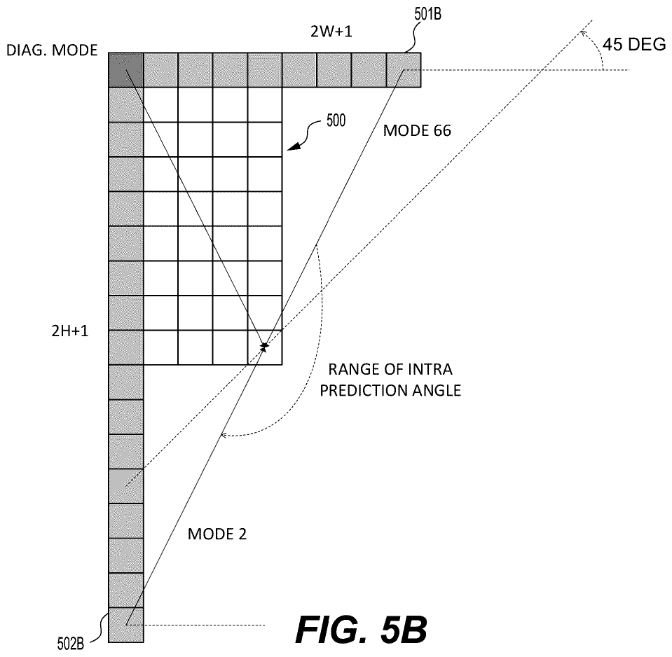

FIGS. 5A-5B show examples of a reference configuration for a non-square block 500. Top references 501A and 501B are defined as 2 W+1, where W denotes a width of the non-square block 500. Left references 502A and 502B are defined as 2H+1, where H denotes a height of the non-square block 500.

A number of replaced modes in the WAIP modes depends on an aspect ratio of a non-square block. The replaced intra prediction modes are illustrated in the table below.

TABLE 3

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Modes 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

In HEVC, every intra-coded block has a square shape and a length of each side of the block is a power of 2. Thus, no division operations are required to generate an intra-predictor using DC mode. In VVC, a block can have a rectangular shape that necessitates the use of a division operation of the block. To avoid division operations for DC prediction, only a longer side of a non-square block is used to compute an average for the non-square block.

In addition, the intra prediction modes 420 can include cross-component linear model (CCLM) modes. The CCLM modes can be represented by modes 81 to modes 83 in an example.

### IV. Most Probable Mode (MPM) List Generation

An MPM list can be used to improve coding efficiency and achieve a high compression performance in video coding. In HEVC, the MPM list can include three entities, while in VCC, the MPM list expends to six entities. The entities indicate the most probable intra prediction modes that can be used for intra prediction. The entities located at the top of the MPM list can take fewer bits in coding than the entities at the bottom of the MPM list. Therefore, it would be advantageous to list the entities in an order from the most probable intra prediction mode to the least probable intra prediction mode. To keep the complexity of the MPM list generation low, two available neighboring intra modes are used in constructing the MPM list.

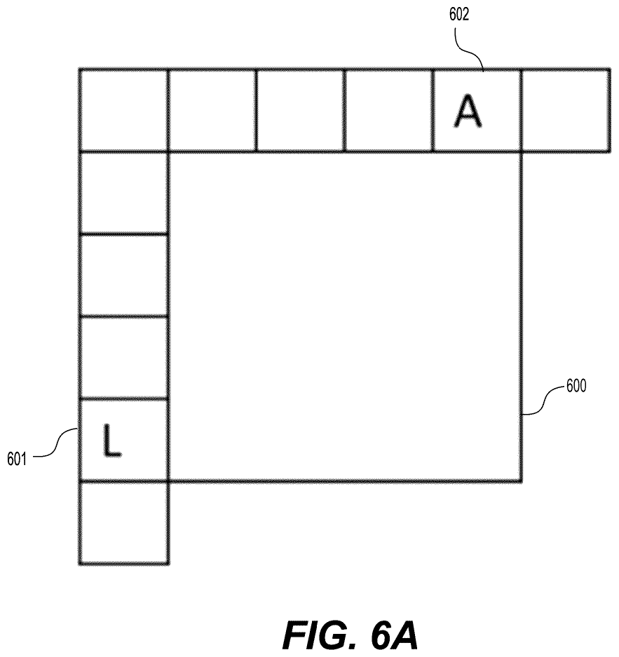

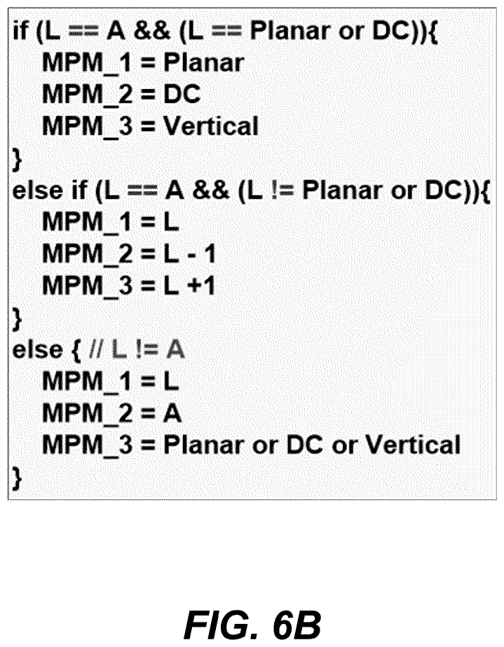

FIG. 6A shows neighboring blocks for constructing an MPM list for a current block 600. The MPM list can be constructed based on an intra mode of a left neighboring block 601 of the current block, denoted as Left (or L), and an intra mode of an above neighboring block 602 of the current block, denoted as Above (or A).

FIG. 6B shows a process for constructing the MPM list used in HEVC. The MPM list can include three entries MPM_1, MPM_2, and MPM_3. For example, when both intra modes of the L and A blocks are DC (or both are planar), the three MPM entries can be planar, DC, and vertical modes.

In VVC, three aspects need to be considered when constructing the MPM list. The three aspects are: default intra modes; neighboring intra modes; and derived intra modes.

An MPM list in VVC can include six entries. In an example, a unified 6-MPM list can be used in VVC for intra blocks irrespective of whether multiple reference line (MRL) and/or intra sub-partition (ISP) coding tools are applied or not. The unified MPM list can be constructed as follows:
When a neighboring block is not available, its intra mode is set to Planar by default.
If both modes Left and Above are non-angular modes:
   MPM list→ {Planar, DC, V, H, V−4, V+4}
If one of modes Left and Above is angular mode, and the other is non-angular:
   Set a mode Max as the larger mode in Left and Above
   MPM list→ {Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→ {Planar, Left, Above, Min−1, Max+1, Min−2}
   Otherwise, if Max−Min is greater than or equal to 62:
      MPM list→ {Planar, Left, Above, Min+1, Max−1, Min+2}
   Otherwise, if Max−Min is equal to 2:
      MPM list→ {Planar, Left, Above, Min+1, Min−1, Max+1}
   Otherwise:
      MPM list→ {Planar, Left, Above, Min−1, −Min+1, Max−1}
If Left and Above are both angular and they are the same:
   MPM list→ {Planar, Left, Left−1, Left+1, Left−2, Left+2}
      In addition, the first bin of the MPM index codeword is context-based adaptive binary arithmetic coding (CABAC) context coded. In total, three contexts are used, corresponding to whether the current intra block is MRL enabled, ISP enabled, or a normal intra block.

During the 6-MPM list generation process, a pruning operation can be used to remove duplicated modes so that only unique modes can be included in the MPM list. For entropy coding of the 61 non-MPM modes, a truncated binary code (TBC) can be used.

### V. Chroma Formats

In VVC, 4:2:0, 4:2:2, and 4:4:4 chroma formats are supported. Chroma derived mode (DM) derivation table for 4:2:2 chroma format was initially ported from HEVC and extends a number of entries from 35 to 67 to align with the extension of intra prediction modes. Since HEVC specification does not support prediction angle below −135 degrees and above 45 degrees, luma intra prediction modes ranging from 2 to 5 are mapped to 2. Therefore, chroma DM derivation table for the 4:2:2 chroma format is updated by replacing some values of the entries of the mapping table to convert prediction angle more precisely for chroma blocks.

### VI. 4-Tap Interpolation Filter and Reference Sample Smoothing

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, two sets of 4-tap IFs replace the lower precision linear interpolation in HEVC, where one is a DCT-based interpolation filter (DCTIF) and the other one is a 4-tap smoothing interpolation filter (SIF). The DCTIF is constructed in the same way as the one used for chroma component motion compensation in both HEVC and VVC. The SIF is obtained by convolving the 2-tap linear interpolation filter with a [1 2 1]/4 filter.

Depending on the intra prediction mode, the following reference samples processing is performed:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80) and Planar mode,
   Group C: remaining directional modes.
If the directional intra-prediction mode is classified as belonging to group A, then no filters are applied to reference samples to generate predicted samples;
If a mode falls into group B and the mode is a directional mode, and all conditions below are true, then a [1, 2, 1] reference sample filter may be applied (depending on the MDIS condition) to reference samples to further copy these filtered values into an intra predictor according to the selected direction, but no interpolation filters are applied. The conditions are:
   refIdx is equal to 0 (no MRL)
   TU size is greater than 32
   Luma
   No ISP block
If a mode is classified as belonging to group C, the MRL index is equal to 0, and the current block is not ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min (Abs (predModeIntra−50), Abs (predModeIntra−18))
   Set nTbS equal to (Log 2 (W)+Log 2 (H))>>1
   Set intraHorVerDistThres[nTbS] as specified below:

TABLE 4

| | nTbS = 2 | nTbS = 3 | nTbS = 4 | nTbS = 5 | nTbS = 6 | nTbS = 7 |
|---|---|---|---|---|---|---|
| intraHorVerDistThres | 24 | 14 | 2 | 0 | 0 | 0 |
| [nTbS] | | | | | | |

If minDistVerHor is greater than intraHorVerDistThres[nTbS], SIF is used for the interpolation
Otherwise, DCTIF is used for the interpolation

### VII. Intra Mode Look-Up Table

In this disclosure, a block can represent a CTU, a CU, a PU, a TU, a CB, a sub-block, or the like.

The present disclosure provides embodiments for intra predicting a current block in video data using an intra mode look-up table (IMLUT). The IMLUT can have one or more entries each indicating a different intra prediction mode. The one or more intra prediction modes of the IMLUT can be a subset of all available intra prediction modes that are available for intra predicting the current block, and can be from, but is not limited to, various video coding standards such as HEVC, VCC, and enhanced compression model (ECM). For example, the one or more intra prediction modes can include DC mode, planar mode, CCLM modes, angular modes, etc. The IMLUT can be used for intra mode coding such as intra mode prediction and/or intra mode signaling.

In an embodiment, the IMLUT can be derived during a coding process of the video data. For example, the IMLUT can be maintained during an encoding and/or decoding process of the video data. Whenever there is a block coded using an intra mode, the associated intra mode information of the block can be added to a last entry of the IMLUT as a new intra mode. When the new intra mode is inserted into the IMLUT, a constrained first-in-first-out (FIFO) rule can be utilized. A redundancy check can be applied to find whether there is an intra mode in the IMLUT identical to the new intra mode. If found, the identical intra mode in the IMLUT can be removed and all the intra modes afterwards can be moved forward. Then, the new intra mode can be inserted at the last entry of the IMLUT. The IMLUT can be reset (or emptied) according to a pre-defined rule or instruction. In an example, the IMLUT can be reset when N CTU row(s) is encountered, where N is an integer greater than 0 and can be predefined. In an example, the IMLUT can be reset when a new tile, a new slice, or a new picture is encountered.

In an embodiment, after one slice (or picture) of the video data is coded, IMLUT(s) of the slice (or picture) can be referenced (or used) by the following slides (or pictures). That is, IMLUT(s) of a previously coded slice (or picture) can be used for the intra mode coding of a current slice (or picture). Moreover, one or more additional constraints can be applied to the use of the IMLUT(s) of the previously coded slice (or picture). In an example, the IMLUT derived for the previously coded slice (or picture) can be referenced by a block within the current slice (or picture) having the same temporal layer with the previously coded slice (or picture). In an example, the IMLUT derived for the previously coded slice (or picture) can be referenced by a block within the current slice (or picture) having the same or higher temporal layer compared to the previously coded slice (or picture). In an example, the IMLUT derived from a reference picture of the current slice (or picture) can be referenced by a block within the current slice (or picture). In an example, the IMLUT derived from a collocated reference picture of the current slice (or picture) can be referenced by a block within the current slice (or picture).

It is noted that a temporal layer can be represented by a temporal layer index. In an example, a bigger temporal layer index indicates a higher temporal layer.

In an embodiment, IMLUT(s) can be signaled into (or received from) a bitstream of the video data at a sequence level (e.g., a sequence parameter set), a picture level (e.g., a picture parameter set, an adaptation parameter set, or a picture header), a slice level (e.g., a slice header), a CTU-level, a CU level, and/or a block level.

In an embodiment, when a current block is coded in an intra mode, only the one or more intra prediction modes in the IMLUT of the current block can be used in intra mode coding of the current block. For example, when signaling the intra mode of the current block, only the one or more intra prediction modes in the IMLUT can be considered for intra mode coding of the current block.

In an embodiment, blocks with different coding information can maintain their own separate IMLUTs. That is, the IMLUT of the current block can depend on the coding information of the current block. The coding information can include, but is not limited to, a block size of the current block, and a block shape of the current block (e.g., a square shape, a non-square shape, a shape with a height being longer than a width, and/or a shape with a width being longer than a height).

According to aspects of the disclosure, an intra prediction mode list can be constructed for intra predicting the current block based on the IMLUT of the current block.

In an embodiment, the intra prediction mode list can include an MPM list and/or a non-MPM list.

In an embodiment, the one or more intra prediction modes of the IMLUT can be inserted into the MPM list and/or can have a higher priority to be considered in the intra mode derivation and/or prediction process than other intra prediction modes which are not used in neighboring blocks of the current block.

In an embodiment, when constructing the MPM list and/or the non-MPM list, the one or more intra prediction modes in the IMLUT can be inserted before intra prediction modes which are not in the IMLUT.

In an embodiment, the one or more intra prediction modes in the IMLUT can be inserted into the MPM list according to a predefined order or a predefined way. In an example, the MPM list can be constructed in a way that only the one or more intra prediction modes in the IMLUT can be inserted into the MPM list, and an intra prediction mode that is not in the IMLUT should not be inserted into the MPM list. In an example, the MPM list can be constructed in a way that the one or more intra prediction modes in the IMLUT are inserted in front of an intra prediction mode that is not in the IMLUT. In other words, the one or more intra prediction modes in the IMLUT have a higher priority when being inserted into the MPM list compared to the intra prediction mode that is not in the IMLUT.

In an embodiment, the MPM list can include multiple sub-lists which can be constructed using the same way as any method presented in this disclosure for constructing the MPM list.

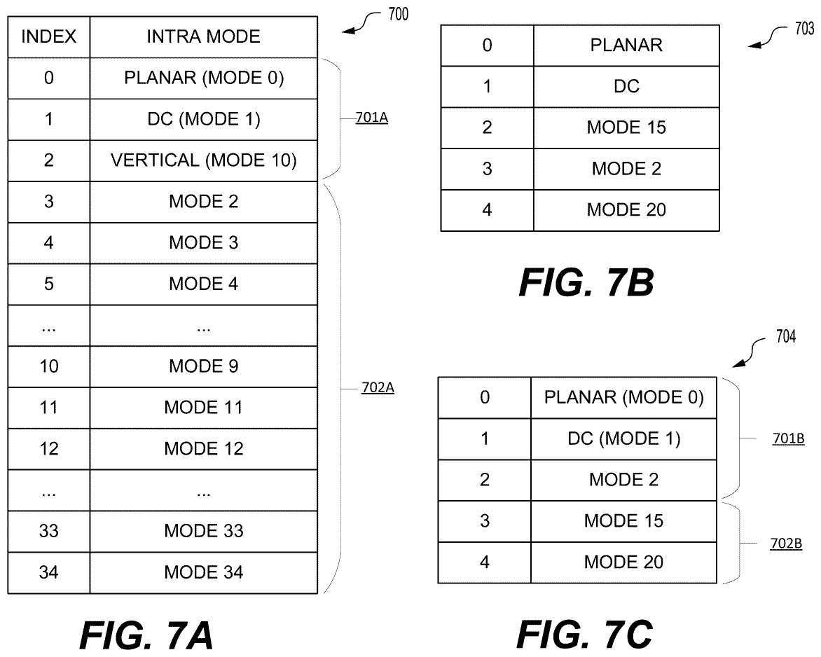

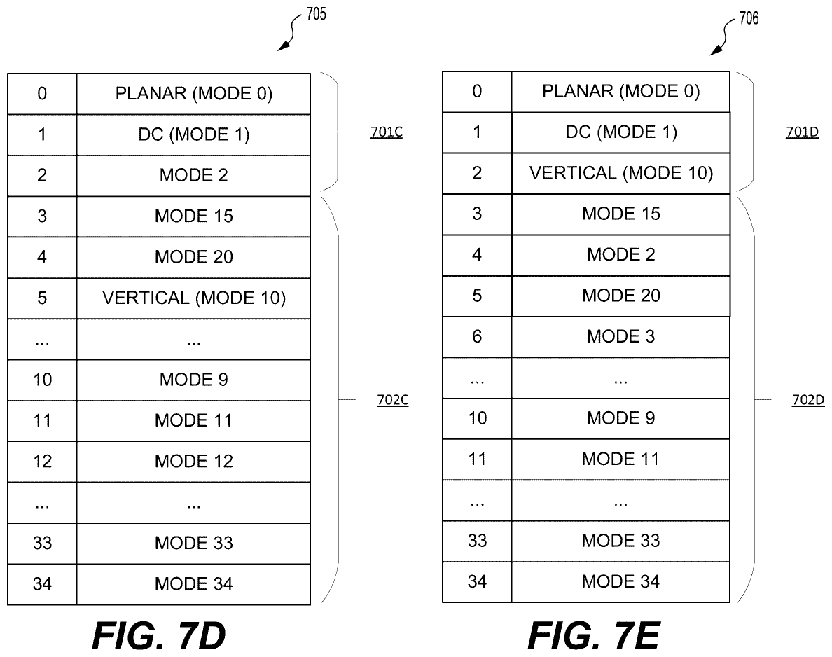

FIGS. 7A-7E show examples of constructing an intra prediction mode list of a current block based on an IMLUT of the current block in HEVC according to embodiments of the disclosure.

Specifically, FIG. 7A shows an exemplary intra prediction mode list 700 in HEVC. The intra prediction mode list 700 can include an MPM list 701A and a non-MPM list 702A. The MPM list 701A is generated based on neighboring blocks of the current block. In an example, in the intra prediction mode list 700, intra prediction modes in the MPM list 701A can be listed on top of intra prediction modes in the non-MPM list 702A. In FIG. 7A, it is assumed that intra modes of the left and above neighboring blocks of the current block are both planar modes or DC modes, so that the MPM list 701A includes planar mode, DC mode, and vertical mode, as described in section IV and FIG. 6B. It is noted that the intra prediction modes in the MPM list 701A are not limited in this disclosure. The intra prediction modes in the non-MPM list 702A can be arranged based on a predefined order, such as an ascending order of mode indexes of the intra prediction modes of the non-MPM list 702A.

FIG. 7B shows an exemplary IMLUT 703 of the current block. The IMLUT 703 can include 5 entries that include planar mode, DC mode, intra mode 15, intra mode 2, and intra mode 20.

In an embodiment, the intra prediction mode list of the current block can only be constructed by inserting the intra prediction modes that are in the IMLUT 703.

FIG. 7C shows an example of constructing an intra prediction mode list 704 of the current block by only using the intra prediction modes in the IMLUT 703, according to an embodiment of the disclosure. The order of the intra prediction modes being inserted into the intra prediction mode list 704 can be based on a predefined rule, such as an ascending order of mode indexes of the intra prediction modes in the IMLUT 703. Therefore, the planar mode, DC mode, intra mode 2, intra mode 15, and intra mode 20 can be sequentially inserted into the intra prediction mode list 704. The intra prediction mode list 704 can include an MPM list 701B, which includes the planar mode, DC mode, and intra mode 2, and a non-MPM list 702B, which includes intra mode 15 and intra mode 20. It can be seen that vertical mode is replaced with intra mode 2 in the MPM list 701B because only the intra prediction modes in the IMLUT 703 can be used in constructing the intra prediction mode list 704.

In an embodiment, the intra prediction mode list of the current block can be constructed by inserting the intra prediction modes in the IMLUT before inserting an intra prediction mode that is not in the IMLUT.

FIG. 7D shows an example of constructed an intra prediction mode list 705 by inserting intra modes in the IMLUT 703 before an intra prediction mode that is not in the IMLUT 703, according to an embodiment of the disclosure. An order of inserting the intra prediction modes in the IMLUT 703 into the intra prediction mode list 705 can be based on a predefined rule, for example, an ascending order of the mode indexes of the intra prediction modes. Accordingly, planar mode, DC mode, intra mode 2, intra mode 15, and intra mode 20 can be sequentially inserted into the intra prediction mode list 705. Planar mode, DC mode, and intra mode 2 can form an MPM list 701C, in which intra mode 2 replaces vertical mode in the MPM list 701A. Accordingly, vertical mode can be inserted right after intra mode 20, and other intra prediction modes that are not in the IMLUT 703 can be inserted based on a predefined rule, such as an ascending order of mode indexes of the other intra prediction modes that are not in the IMLUT 703. The intra prediction mode list 705 can include a non-MPM list 702C, which includes from vertical mode to intra mode 34.

In an embodiment, the intra prediction mode list 705 can be constructed by first inserting the intra prediction modes in IMLUT 703 and then inserting the intra prediction modes outside the IMLUT 703, for example, according to an ascending order of the mode indexes.

In an embodiment, the intra prediction mode list 705 can be constructed by first constructing the intra prediction mode list 700 and then inserting the intra prediction modes in the IMLUT 703 to positions before the intra prediction modes outside the IMLUT 703.

In an embodiment, when the MPM list 701A includes another intra mode (e.g., intra mode 30) instead of planar mode or DC mode, the intra mode 30 can be inserted right after vertical mode (mode 10) in the intra prediction mode list 705. That is, the intra prediction modes in the MPM list 701A are inserted in the intra prediction list 705, right after the intra prediction modes in the IMLUT 703, according to an ascending order of mode indexes of the intra prediction modes in the MPM list 701A for example. Then, the intra prediction modes that are outside of the IMLUT 703 and the MPM list 701A can be inserted into the intra prediction mode list 705.

In an embodiment, the intra prediction mode list of the current block can be constructed by inserting the intra prediction modes in the IMLUT at predetermined locations in the intra prediction mode list.

FIG. 7E shows an example of constructed an intra prediction mode list 706 by inserting the intra prediction modes in the IMLUT 703 after an MPM list, according to an embodiment of the disclosure. The intra prediction mode list 706 can include an MPM list 701D and a non-MPM list 702D. The MPM list 701D can be the same as the MPM list 701A. The intra prediction modes in the IMLUT 703 can be inserted right after the MPM list 701D. Since planar mode and DC mode are already included in the MPM list 701D of the intra prediction mode list 706, the first intra mode in the IMLUT 703 to be inserted after the MPM list 701D is mode 15, followed by mode 2 and mode 20. In an example, an order of inserting the intra prediction modes in the IMLUT 703 into the intra prediction mode list 706 can be based on an order of the IMLUT 703. Therefore, mode 15 is inserted before mode 2. In an example, the order of inserting the intra prediction modes in the IMLUT 703 into the intra prediction mode list 706 can be based on an ascending order of the mode indexes. In such an example, mode 15 is inserted after mode 2. After the intra prediction modes in the IMLUT 703 are inserted into the intra prediction mode list 706, the intra prediction modes outside the IMLUT 703 can be inserted into the intra prediction mode list 706, according to an ascending order of the mode indexes for example.

It is noted that the embodiments and methods presented in this disclosure are not limited to be used in HEVC, although the examples of constructing the intra prediction mode list using intra prediction modes in the IMLUT are described based on HEVC. In an embodiment, a similar construction of the intra prediction mode list can be performed based on VVC, or any other video coding standards and/or process.

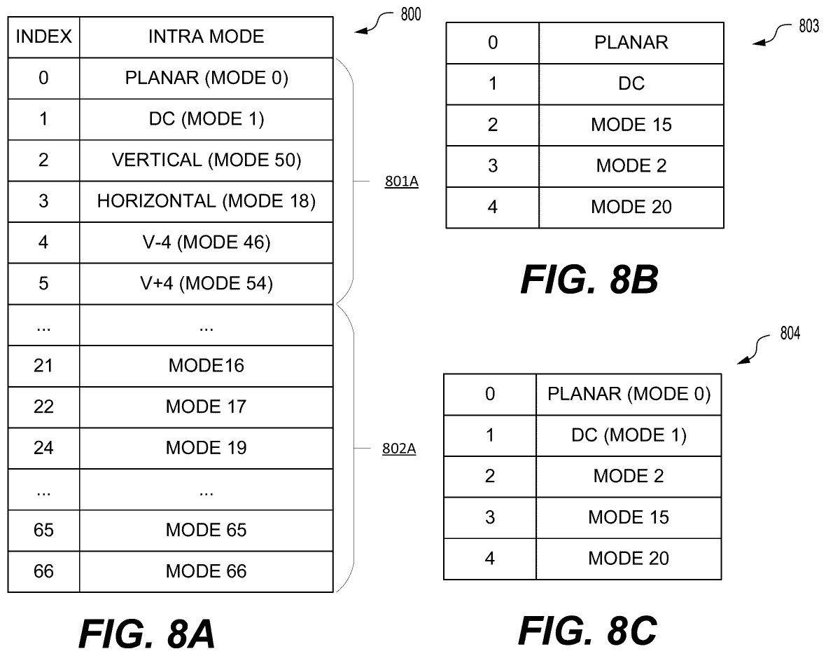

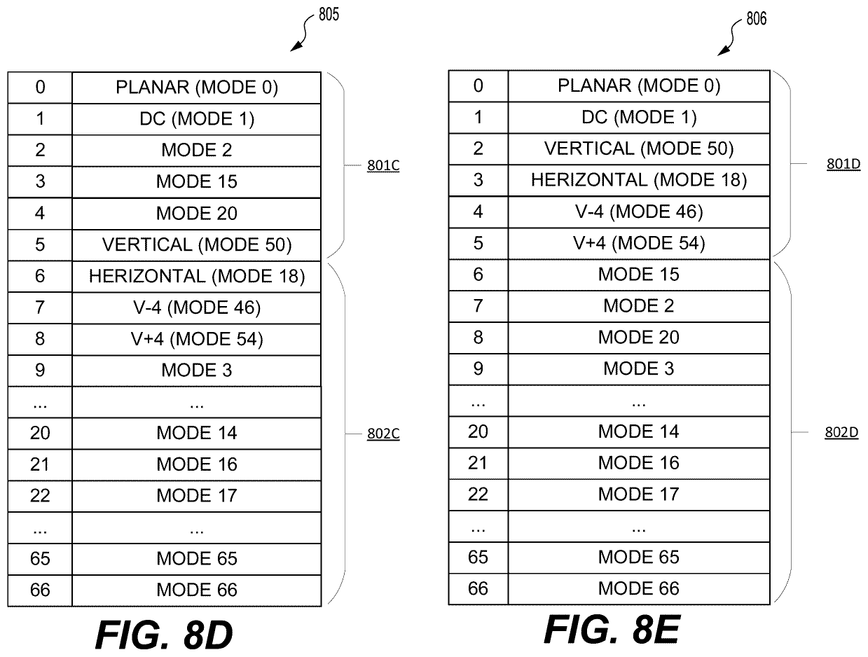

FIGS. 8A-8E show examples of constructing an intra prediction mode list of a current block based on an IMLUT of the current block in VVC according to embodiments of the disclosure. The construction of the intra prediction mode list in FIGS. 8A-8E can be similar to the embodiments in FIGS. 7A-7E.

Specifically, FIG. 8A shows an exemplary intra prediction mode list 800 in VVC. The intra prediction mode list 800 can include an MPM list 801A and a non-MPM list 802A. The MPM list 801A is generated based on neighboring blocks of the current block. In an example, in the intra prediction mode list 800, intra prediction modes in the MPM list 801A can be listed on top of intra prediction modes in the non-MPM list 802A. In FIG. 8A, it is assumed that intra modes of the left and above neighboring blocks of the current block are both planar modes or DC modes, so that the MPM list 801A includes planar mode, DC mode, and vertical mode, horizontal mode, V−4 (mode 46), and V+4 (mode 54), as described in section IV. It is noted that the intra prediction modes in the MPM list 801A are not limited in this disclosure. The intra prediction modes in the non-MPM list 802A can be arranged based on a predefined order, such as an ascending order of mode indexes of the intra prediction modes of the non-MPM list 802A.

FIG. 8B shows an exemplary IMLUT 803 of the current block. The IMLUT 803 can include 5 entries that include planar mode, DC mode, intra mode 15, intra mode 2, and intra mode 20.

In an embodiment, the intra prediction mode list of the current block can only be constructed by inserting the intra prediction modes that are in the IMLUT 803.

FIG. 8C shows an example of constructing an intra prediction mode list 804 of the current block by only using the intra prediction modes in the IMLUT 803, according to an embodiment of the disclosure. The order of the intra prediction modes being inserted into the intra prediction mode list 804 can be based on a predefined rule, such as an ascending order of mode indexes of the intra prediction modes in the IMLUT 803. Therefore, the planar mode, DC mode, intra mode 2, intra mode 15, and intra mode 20 can be sequentially inserted into the intra prediction mode list 804.

In an embodiment, the intra prediction mode list of the current block can be constructed by inserting the intra prediction modes in the IMLUT before inserting an intra prediction mode that is not in the IMLUT.

FIG. 8D shows an example of constructed an intra prediction mode list 805 by inserting intra modes in the IMLUT 803 before an intra prediction mode that is not in the IMLUT 803, according to an embodiment of the disclosure. An order of inserting the intra prediction modes in the IMLUT 803 into the intra prediction mode list 805 can be based on a predefined rule, for example, an ascending order of the mode indexes of the intra prediction modes. Accordingly, planar mode, DC mode, intra mode 2, intra mode 15, and intra mode 20 can be sequentially inserted into the intra prediction mode list 805. The intra prediction modes of the MPM list 801A can be added after the IMLUT 803 in the intra prediction mode list 805. Since planar mode and DC mode are already included in the IMLUT 803, vertical mode, horizontal mode, V−4 (mode 46), and V+4 (mode 54) in the MPM list 801A can be sequentially added after the IMLUT 803 in the intra prediction mode list 805. Planar mode, DC mode, intra mode 2, intra mode 15, intra mode 20, and vertical mode can form an MPM list 801C of the intra prediction mode list 805. Other intra prediction modes can form a non-MPM list 802C of the intra prediction mode list 805.

In an embodiment, the intra prediction mode list of the current block can be constructed by inserting the intra prediction modes in the IMLUT at predetermined locations in the intra prediction mode list.

FIG. 8E shows an example of constructed an intra prediction mode list 806 by inserting the intra prediction modes in the IMLUT 803 after an MPM list, according to an embodiment of the disclosure. The intra prediction mode list 806 can include an MPM list 801D and a non-MPM list 802D. The MPM list 801D can be the same as the MPM list 801A. The intra prediction modes in the IMLUT 803 can be inserted right after the MPM list 801D. Since planar mode and DC mode are already included in the MPM list 801D of the intra prediction mode list 806, the first intra mode in the IMLUT 803 to be inserted after the MPM list 801D is mode 15, followed by mode 2 and mode 20. In an example, an order of inserting the intra prediction modes in the IMLUT 803 into the intra prediction mode list 806 can be based on an order of the IMLUT 803. Therefore, mode 15 is inserted before mode 2. In an example, the order of inserting the intra prediction modes in the IMLUT 803 into the intra prediction mode list 806 can be based on an ascending order of the mode indexes. In such an example, mode 15 is inserted after mode 2. After the intra prediction modes in the IMLUT 803 are inserted into the intra prediction mode list 806, the intra prediction modes outside the IMLUT 803 can be inserted into the intra prediction mode list 806, according to an ascending order of the mode indexes for example.

In an embodiment, the MPM list can be first constructed based on the intra prediction mode of the Left and Above neighboring block, followed by the intra prediction modes in the IMLUT. The intra prediction mode of the left neighboring block is denoted as Left and the intra prediction mode of the above neighboring block is denoted as Above. The MPM list is constructed as follows:
If a current block does not have a neighboring block, the intra prediction mode is set to Planar by default.
If both modes Left and Above are non-angular modes:
   MPM list→{Planar, DC, V, H, V−4, V+4}
If one of the modes Left and Above is an angular mode, and the other is non-angular:
   Set a mode Max as the larger mode between Left and Above
   MPM list→{Planar, Max, Max−1, Max+1, Max−2, Max+2}
If Left and Above are both angular but they are different:
   Set a mode Max as the larger mode between Left and Above
   Set a mode Min as the smaller mode between Left and Above
   If Max−Min is equal to 1:
      MPM list→take the first N modes from {Planar, Left, Above, IMLUT Modes, Min−1, Max+1, Min−2}, where N is the size of the MPM list
   if Max−Min is greater than or equal to 62:
      MPM list→take the first N modes from {Planar, Left, Above, IMLUT Modes, Min+1, Max−1, Min+2}, where N is the size of the MPM list
   if Max−Min is equal to 2:
      MPM list→take the first N modes from {Planar, Left, Above, IMLUT Modes, Min+1, Min−1, Max+1}, where N is the size of the MPM list
   Otherwise:
      MPM list→take the first N modes from {Planar, Left, Above, IMLUT Modes, Min−1, −Min+1, Max−1}, where N is the size of the MPM list
If Left and Above are both angular and they are the same:
   MPM list→take the first N modes from {Planar, Left, IMLUT Modes, Left−1, Left+1, Left−2, Left+2}, where N is the size of the MPM list

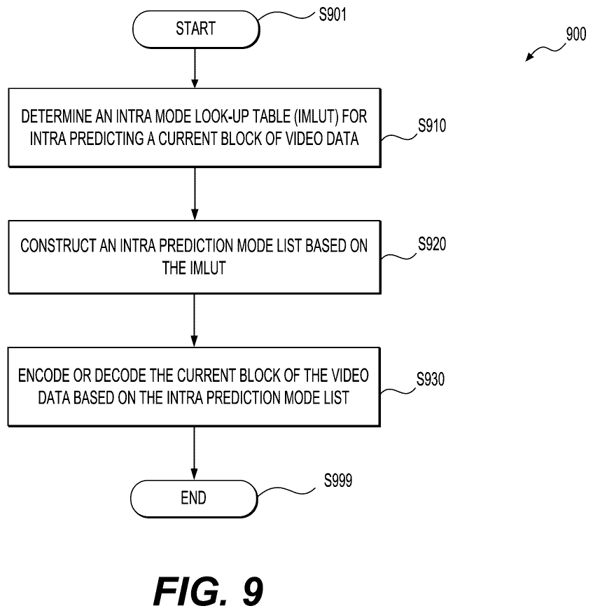

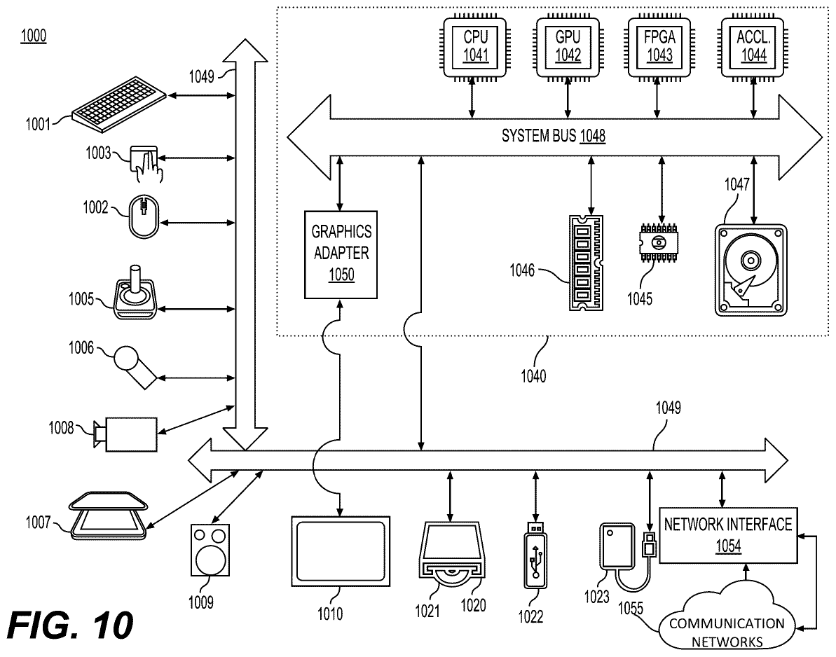

FIG. 9 shows a process 900 of video coding according to an embodiment of the present disclosure. The process 900 can be performed by processing circuitry (e.g., CPU, GPU, or the like) of an apparatus (e.g., apparatus 1000 in FIG. 10). The process 900 can also be implemented as software instructions executed by the processing circuitry of the apparatus. The process 900 can start from S901 and proceed to S910.

At S910, an encoder or decoder determines an IMLUT for intra predicting a current block of video data. The IMLUT can include a subset of all available intra prediction modes that are available for intra predicting the current block. For example, the encoder or decoder can signal or receive syntax elements associated with the IMLUT from a bitstream of the video data at one of a sequence level, a picture level, a slice level, a CTU level, a CU level, or a block level. For example, the encoder or decoder can determine the IMLUT determine the IMLUT based on at least one of a block size or a block shape of the current block of the video data. For example, the encoder or decoder can add an intra prediction mode of the current block into the IMLUT based on a FIFO rule. For example, the encoder or decoder can perform a redundancy check on the intra prediction mode added into the IMLUT.

For example, in response to one of a predefined number of CTU rows, a tile, a slice, or a picture having been processed, the encoder or decoder can clear all intra prediction modes in the IMLUT. For example, the encoder or decoder can determine the IMLUT based on one of the intra modes of all CUs of a previously coded slice or a previously coded picture, the intra modes of all coded CUs of a current slice or a current picture including the current block, the intra modes of all coded CUs of a reference picture of the current block, or the intra modes of all coded CUs of a collocated reference picture of the current block.

At S920, an encoder or decoder constructs an intra prediction mode list based on the IMLUT. For example, the encoder or decoder can construct the intra prediction mode list by only inserting the intra prediction modes in the IMLUT. For example, the encoder or decoder can construct the intra prediction mode list by inserting the intra prediction modes in the IMLUT before inserting the intra prediction modes that are not in the IMLUT. For example, the encoder or decoder can insert an intra prediction mode in an MPM list after the intra prediction modes in the IMLUT and before an intra prediction mode not in the MPM list, and the MPM list can be generated based on neighboring blocks of the current block. For example, the encoder or decoder can construct the intra prediction mode list by inserting the intra prediction modes in the IMLUT according to a predefined order. For example, the predefined order is an ascending order of mode indexes of the intra prediction modes in the IMLUT.

For example, the intra prediction mode list can include an MPM list and a non-MPM list, and the encoder or decoder can construct the MPM list based on the IMLUT. For example, a number of intra prediction modes in the MPM list is M, a number of intra prediction modes in the IMLUT is N, the encoder the decoder can construct the MPM list by inserting the intra prediction modes in the IMLUT into the MPM list before an intra prediction mode not in the IMLUT in response to M>N, and inserting a subset of the intra prediction modes in the IMLUT into the MPM list in response to M≤N. For example, the encoder or decoder can insert at least one remaining intra prediction mode in the IMLUT into the non-MPM list in response to M≤N. For example, the intra prediction mode list includes the MPM list can be generated based on neighboring blocks of the current block and a non-MPM list can be generated based on the IMLUT. For example, the intra prediction modes in the IMLUT can be on top of the non-MPM list.

At S930, an encoder or decoder encodes or decodes the current block of the video data based on the intra prediction mode list. The process 900 can proceed to S999, and terminate at S999.

The techniques described above, can be implemented as computer software using computer-readable instructions and physically stored in one or more computer-readable media. For example, FIG. 10 shows a computer system (1000) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (1000) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), and camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there can also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens (1010)) can be connected to a system bus (1048) through a graphics adapter (1050).

Computer system (1000) can also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) can also include a network interface (1054) to one or more communication networks (1055). The one or more communication networks (1055) can for example be wireless, wireline, optical. The one or more communication networks (1055) can further be local, wide-area, metropolitan, vehicular and industrial, real-time, delay-tolerant, and so on. Examples of the one or more communication networks (1055) include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1040) of the computer system (1000).

The core (1040) can include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage (1047) such as internal non-user accessible hard drives, SSDs, and the like, may be connected through the system bus (1048). In some computer systems, the system bus (1048) can be accessible in the form of one or more physical plugs to enable extensions by additional CPUs, GPU, and the like. The peripheral devices can be attached either directly to the core's system bus (1048), or through a peripheral bus (1049). In an example, the screen (1010) can be connected to the graphics adapter (1050). Architectures for a peripheral bus include PCI, USB, and the like.

CPUs (1041), GPUs (1042), FPGAs (1043), and accelerators (1044) can execute certain instructions that, in combination, can make up the aforementioned computer code. That computer code can be stored in ROM (1045) or RAM (1046). Transitional data can be also be stored in RAM (1046), whereas permanent data can be stored for example, in the internal mass storage (1047). Fast storage and retrieve to any of the memory devices can be enabled through the use of cache memory, that can be closely associated with one or more CPU (1041), GPU (1042), mass storage (1047), ROM (1045), RAM (1046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1000), and specifically the core (1040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1040) that are of non-transitory nature, such as core-internal mass storage (1047) or ROM (1045). The software implementing various embodiments of the present disclosure can be stored in such devices and executed by core (1040). A computer-readable medium can include one or more memory devices or chips, according to particular needs. The software can cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system can provide functionality as a result of logic hardwired or otherwise embodied in a circuit (for example: accelerator (1044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video coding, comprising:
determining an intra mode look-up table (IMLUT) for intra predicting a current block of video data, wherein the IMLUT includes a subset of all available intra prediction modes that are available for intra predicting the current block;
constructing an intra prediction mode list based on the IMLUT; and
encoding or decoding the current block of the video data based on the intra prediction mode list.

2. The method of claim 1, wherein the determining the IMLUT further comprises:
signaling or receiving syntax elements associated with the IMLUT into or from a bitstream of the video data at one of a sequence level, a picture level, a slice level, a coding tree unit (CTU) level, a coding unit (CU) level, or a block level.

3. The method of claim 1, wherein the determining the IMLUT further comprises:
determining the IMLUT based on at least one of a block size or a block shape of the current block of the video data.

4. The method of claim 1, wherein the determining the IMLUT further comprises:
determining the IMLUT based on one of intra prediction modes of all coded CUs of a previously coded slice or a previously coded picture, intra prediction modes of all coded CUs of a current slice or a current picture including the current block, intra prediction modes of all coded CUs of a reference picture of the current block, or intra prediction modes of all coded CUs of a collocated reference picture of the current block.

5. The method of claim 4, wherein a temporal layer of the current picture which includes the current block is the same or higher than a temporal layer of the previously coded picture corresponding to the IMLUT of the current slice or current picture.

6. The method of claim 1, further comprising:
adding an intra prediction mode of the current block into the IMLUT based on a first-in-first-out (FIFO) rule.

7. The method of claim 6, further comprising:
performing a redundancy check on the intra prediction mode added into the IMLUT.

8. The method of claim 1, further comprising:
in response to one of a predefined number of CTU rows, a tile, a slice, or a picture having been processed, clearing all intra prediction modes in the IMLUT.

9. The method of claim 1, wherein the constructing the intra prediction mode list further comprises:
constructing the intra prediction mode list using only intra prediction modes in the IMLUT.

10. The method of claim 1, wherein the constructing the intra prediction mode list further comprises:
inserting intra prediction modes in the IMLUT into the intra prediction mode list before an intra prediction mode not in the IMLUT.

11. The method of claim 10, further comprising:
inserting an intra prediction mode in a most probable mode (MPM) list after the intra prediction modes in the IMLUT and before an intra prediction mode not in the MPM list, the MPM list being generated based on neighboring blocks of the current block.

12. The method of claim 1, wherein the constructing the intra prediction mode list further comprises:
inserting intra prediction modes in the IMLUT into the intra prediction mode list according to a predefined order.

13. The method of claim 12, wherein the predefined order is an ascending order of mode indexes of the intra prediction modes in the IMLUT.

14. The method of claim 1, wherein the intra prediction mode list includes an MPM list and a non-MPM list, and the constructing further comprises:
constructing the MPM list based on the IMLUT.

15. The method of claim 14, wherein a number of intra prediction modes in the MPM list is M, a number of intra prediction modes in the IMLUT is N, and the constructing the MPM list further comprises:
in response to M>N, inserting the intra prediction modes in the IMLUT into the MPM list before an intra prediction mode not in the IMLUT; and
in response to M≤N, inserting a subset of the intra prediction modes in the IMLUT into the MPM list.

16. The method of claim 15, further comprising:
in response to M≤N, inserting at least one remaining intra prediction mode in the IMLUT into the non-MPM list.

17. The method of claim 1, wherein the intra prediction mode list includes an MPM list generated based on neighboring blocks of the current block and a non-MPM list generated based on the IMLUT.

18. The method of claim 17, wherein the intra prediction modes in the IMLUT is on top of the non-MPM list.

19. An apparatus of video coding, comprising:
processing circuitry configured to
determine an intra mode look-up table (IMLUT) for intra predicting a current block of video data, wherein the IMLUT includes a subset of all available intra prediction modes that are available for intra predicting the current block,
construct an intra prediction mode list based on the IMLUT, and
encode or decode the current block of the video data based on the intra prediction mode list.

20. A non-transitory computer-readable medium storing instructions that, when executed by a processor, cause the processor to perform a method, the method comprising:
determining an intra mode look-up table (IMLUT) for intra predicting a current block of video data, wherein the IMLUT includes a subset of all available intra prediction modes that are available for intra predicting the current block;
constructing an intra prediction mode list based on the IMLUT; and
encoding or decoding the current block of the video data based on the intra prediction mode list.
